(19) United States
(12) Patent Application Publication
(10) Pub. No.: US 2017/0215231 A1
(43) Pub. Date: Jul. 27, 2017

(54) GLASS CERAMIC COOKTOP WITH INFRARED SENSOR

(71) Applicant: SCHOTT AG, Mainz (DE)

(72) Inventors: Birgit Doerk, Mainz (DE); Matthias Bockmeyer, Mainz (DE); Thomas Zenker, Nieder-Olm (DE); Evelin Weiss, Mainz (DE); Gerold Ohl, Sulzheim (DE); Martin Taplan, Mainz (DE); Roland Dudek, Bad Kreuznach (DE); Sasha Backes, Ruedesheim (DE)

(73) Assignee: SCHOTT AG, Mainz (DE)

(21) Appl. No.: 15/411,745

(22) Filed: Jan. 20, 2017

(30) Foreign Application Priority Data
Jan. 21, 2016 (DE) 102016101048.0

(51) Int. Cl. H05B 1/02; H05B 6/12; C03C 3/097; C03C 3/083; C03C 3/093; H05B 3/74; C03C 3/087

(52) U.S. Cl. CPC H05B 1/0266; H05B 3/74; H05B 6/1209; H05B 3/744; C03C 3/087; C03C 3/083; C03C 3/093; C03C 3/097; H05B 2213/07

(57) ABSTRACT

A cooktop is provided that includes a glass ceramic cooking plate that exhibits enhanced mechanical strength and at the same time increased spectral transmittance in the infrared range. The glass ceramic cooking plate makes it possible to detect, through the glass ceramic cooking plate, the temperature of a piece of cookware placed thereon using an infrared sensor, and to perform an automated cooking process in response thereto.

### CROSS REFERENCE TO RELATED APPLICATIONS

This application claims benefit under 35 U.S.C. §119(a) of German Patent Application No. 10 2016 101 048.0 filed Jan. 21, 2016, the entire contents of which are incorporated herein by reference.

### BACKGROUND

1. Field of the Invention

The invention relates to a cooktop with a glass ceramic cooking plate with at least one cooking zone and at least one heater arranged below the glass ceramic cooking plate in the region of the cooking zone.

2. Description of Related Art

Due to their low thermal expansion, glass ceramics based on lithium aluminosilicate (LAS) are used for many applications where high temperatures and temperature differences are found. For example, glass ceramic plates are used as cooking plates of cooktops. The energy for cooking is provided by heaters arranged below the glass ceramic cooking plate, which may be configured as radiant, halogen, or induction heaters, for example, but as well as resistance heaters which are indirectly or directly applied to the underside of the glass ceramic cooking plate. The energy of the heaters is transmitted through the glass ceramic cooking plate to a piece of cookware placed thereon, such as a pot or a pan. Depending in particular on the selected power settings, the employed cookware, and the type of heater, the glass ceramic cooking plate will also be heated.

A desired temperature of the food to be cooked is adjusted manually by suitably setting the output power of the heater. In order to provide for at least partially automated cooking it is desirable to detect the temperature of the food to be cooked and to control the heater output power as a function of the cooked food temperature.

GB 2 072 334 discloses an arrangement with an infrared sensor. A portion of the heat radiation of a pot bottom is collected by a suitably shaped reflector and directed to the infrared sensor, directly or via optical fibers. According to the illustrated exemplary embodiment, the pot is placed on a contact heater, and the reflector is arranged between the spiral heating elements and faces the bottom of the pot. The temperature of the pot bottom can be determined from the sensed infrared radiation and the temperature of the cooked food can be deduced therefrom. Closed-loop control of the heater can be achieved as a function of the temperature of the cooked food using suitable power electronics. The arrangement is not suitable for being used underneath today's known glass ceramic cooking plates, because the latter have a transmittance in the wavelength range of the heat radiation emitted by the pot that is too low to allow for a sufficiently accurate measurement of the pot bottom temperature. This is particularly true for low pot bottom temperatures in the range from 70 to 150° C. frequently occurring during common cooking processes.

DE 198 56 140 A1 discloses a sensor-controlled cooktop with a glass ceramic cooking plate and heaters arranged below the glass ceramic cooking plate. A heat radiation sensing unit is aligned so as to face the underside of the glass ceramic cooking plate in the area of a cooking zone and determines the heat radiation emitted by the glass ceramic cooking plate. The output power of an associated heater is controlled as a function of the sensed heat radiation and hence of the temperature of the glass ceramic cooking plate in the area of the measuring spot of the heat radiation sensing unit. In order to preferably detect only the heat radiation emanating from the glass ceramic cooking plate, the latter has a transmittance limited to less than 30%, preferably less than 10% in the spectral measurement range of the heat radiation sensing unit. From the temperature of the glass ceramic cooking plate, the temperature of a cooking vessel placed thereon is deduced and controlled accordingly. However, a drawback is that the relationship between the glass ceramic temperature and the temperature of the cooking vessel depends on many factors, for example on the quality of a pot placed thereon, or on the food to be heated. Therefore, the arrangement only leads to satisfying results under tightly defined requirements and specifications regarding the employed cookware and the prepared food.

Known on the market are moreover glass ceramic cooking plates which have IR sensors arranged below the glass ceramic and within the induction coil. Such IR sensors arranged in this manner have their greatest sensitivity in the wavelength range of less than 3000 nm.

From document DE 295 22 310 U1, an infrared-controlled cooking unit for a glass ceramic cooktop is known. At least one infrared sensor is arranged slightly elevated above the cooktop and permits to measure the wall temperature of a cooking vessel placed thereon, which is then used for controlling a cooking process by correspondingly controlling a heater. In order to take into account the different emission coefficients of different cooking pot materials, there have been suggested different coatings on the employed cooking vessels in the region of the measuring spot of the infrared sensor. The exact knowledge of the wall temperature of the cooking vessel allows for accurate control of the temperature of the contained food to be cooked. However, a drawback hereof is that the infrared sensor has to be arranged above the glass ceramic cooking plate. This affects the aesthetic impression of the cooktop as well as options for positioning cooking pots or other cookware on the cooking surface or the surrounding working surface. Furthermore, the infrared sensor protruding from the working plane might be easily damaged, for example when handling with heavy cooking pots. Retractable infrared sensors that have been proposed are mechanically complex.

The manufacture of suitable glass ceramics and their use in the field of cooktops has been described in literature (e.g. “Low Thermal Expansion Glass Ceramics”, editor H. Bach, ISBN 3-540-58598-2). Starting with a green glass plate that is produced by a melting and subsequent shaping process, ceramization of the material is accomplished by a suitable temperature treatment during which initially nuclei are created on which so-called high-quartz mixed crystals (HQMK) will grow, controlled by an appropriate temperature-time curve. In contrast to the surrounding glass matrix, these HQMK have an orientation-dependent and negative thermal expansion coefficient. If a suitable ratio between the crystalline and the amorphous phase is given, a very low expansion coefficient of the glass ceramic will result over a wide temperature application range. The so produced glass ceramic cooking plates which are predominantly used today and which include HQMK as the predominant crystal phase are dark colored in the visible range and exhibit little or no diffusion. Due to the dark coloring, insight into the cooktop is prevented so that it appears black under incident light. However, a light-emitting heater or a display or light source arranged below the glass ceramic cooking plate is seen through the glass ceramic cooking plate. A drawback of the glass ceramic cooking plates used today is that they are not sufficiently transmissive in the spectral measurement range of known infrared sensors for allowing to perform a useful optical temperature measurement of a pot bottom through the glass ceramic and to enable automated closed-loop control of a cooking process in this way.

It is known that in a further temperature treatment of the glass ceramic, the HQMK can be converted into keatite mixed crystals (KMK). KMK also have orientation-dependent negative thermal expansion coefficients, but different from those of the HQMK. Furthermore, the crystalline types differ in their optical properties. The strong crystal growth during the conversion of HQMK into KMK causes scattering centers to be formed, so that a translucent or opaque glass ceramic is obtained. Some of the so produced translucent or opaque glass ceramics exhibit increased transmittance in the spectral measurement range of known infrared sensors, which allows for determination of a pot bottom temperature by IR measurement through the glass ceramic. As a drawback, displays or light-emitting heaters arranged below such a glass ceramic cooking plate are not seen by a user, or only strongly distorted, due to the strong diffusing nature of the glass ceramic cooking plate. Under incident light, such glass ceramic cooking plates mostly appear white, which is not desired for many applications.

Due to the low coefficient of thermal expansion and the high application temperatures, appropriate strengthening of the glass ceramic cooking plate is complicated. In order to nevertheless achieve the required strength, in particular the required impact strength and flexural strength, the glass ceramic cooking plates are produced with a sufficient material thickness. Furthermore, it is known to provide knobs on the lower surface of the glass ceramic cooking plate which, when in use, is predominantly subjected to tensile stress. The knobs separate the areas of highest tensile stress in the valleys between knobs from the areas of most severe surface defects which constitute potential crack starting points and which, for structural causes, arise on the top of the knobs. In this way it is possible to significantly increase the strength of glass ceramic cooking plates. For known glass ceramic cooking plates this means that a knobbed glass ceramic plate with a material thickness of greater than or equal to 3.8 mm meets the strength requirements for the glass ceramic cooktop. The strength requirements are specified by relevant standards such as EN 60335, UL 858, or CSA 22.2.

During cooking operation, the material thickness has an influence on the energy flow through the glass ceramic cooking plate. Therefore it has an impact on the controllability of a cooking process and on energy losses. For these reasons and for saving material and energy in the manufacturing of the glass ceramic cooking plate, it is desired to make the cooking plate as thin as possible.

### SUMMARY

An object of the invention is to provide a cooktop with a glass ceramic cooking plate which allows simple and precise control of a cooking process. At the same time, the glass ceramic cooking plate should be dark colored in the visible range, but should exhibit no or only slight diffusing properties. With the present invention, these hitherto contradictory objectives are achieved in a surprisingly simple manner.

The object of the invention is achieved by a cooktop comprising a glass ceramic cooking plate with at least one cooking zone and at least one heater arranged below the glass ceramic cooking plate in the region of the cooking zone, wherein preferably at least one infrared sensor is arranged in or at the cooktop, wherein the preferred infrared sensor has a sensing area arranged so as to face the cooking zone through the glass ceramic cooking plate, wherein the preferred infrared sensor is preferably connected to electronics, wherein the preferred electronics are in particular adapted to control the power of the at least one heater as a function of an output signal of the infrared sensor, and wherein the glass ceramic cooking plate is made of a lithium aluminosilicate glass ceramic (LAS glass ceramic) containing the following constituents in the following composition (in percent by weight):

| | |
|---|---|
| Al₂O₃ | 18-23 |
| Li₂O | 2.5-4.2 |
| SiO₂ | 60-69 |
| ZnO | 0-2 |
| Na₂O + K₂O | 0.2-1.5 |
| MgO | 0-1.5 |
| CaO + SrO + BaO | 0-4 |
| B₂O₃ | 0-2 |
| TiO₂ | 2.3-4.5 |
| ZrO₂ | 0.5-2 |
| P₂O₅ | 0-3 |
| SnO₂ | 0-<0.6 |
| Sb₂O₃ | 0-1.5 |
| As₂O₃ | 0-1.5 |
| TiO₂ + ZrO₂ + SnO₂ | 3.8-6 |
| preferably V₂O₅ | 0.01-0.08 |
| Fe₂O₃ | 0.008-0.3, |

and

optionally further coloring oxides, in total up to a maximum amount of 1.0 wt %, wherein the glass ceramic cooking plate has a gradient layer at its surface or towards its surface and an underlying core, wherein the glass ceramic cooking plate includes keatite mixed crystal (KMK) as the predominant crystal phase in the core and high-quartz mixed crystal (HQMK) as the predominant crystal phase in the gradient layer, and wherein in a depth of 10 μm or more, the KMK crystal phase content exceeds 50% of the total of the HQMK and KMK crystal phase contents. For dyed glass ceramics, a lower limit of 0.03 wt % for the amount of Fe₂O₃ may be advantageous in this case.

A particularly preferred embodiment relates to a cooktop comprising a glass ceramic cooking plate with at least one cooking zone and at least one heater arranged below the glass ceramic cooking plate in the region of the cooking zone, wherein at least one infrared sensor is arranged in or at the cooktop, wherein the infrared sensor has a sensing area arranged so as to face the cooking zone through the glass ceramic cooking plate, wherein the infrared sensor is connected to electronics, wherein the electronics are in particular adapted to control the power of the at least one heater as a function of an output signal of the infrared sensor, and wherein the glass ceramic cooking plate is made of a lithium aluminosilicate glass ceramic (LAS glass ceramic) containing the following constituents in the following composition (in percent by weight):

| | |
|---|---|
| Al₂O₃ | 18-23 |
| Li₂O | 2.5-4.2 |
| SiO₂ | 60-69 |
| ZnO | 0-2 |
| Na₂O + K₂O | 0.2-1.5 |
| MgO | 0-1.5 |
| CaO + SrO + BaO | 0-4 |
| B₂O₃ | 0-2 |
| TiO₂ | 2.3-4.5 |
| ZrO₂ | 0.5-2 |
| P₂O₅ | 0-3 |
| SnO₂ | 0-<0.6 |
| Sb₂O₃ | 0-1.5 |
| As₂O₃ | 0-1.5 |
| TiO₂ + ZrO₂ + SnO₂ | 3.8-6 |
| preferably V₂O₅ | 0.01-0.08 |
| Fe₂O₃ | 0.008-0.3, |

and

optionally further coloring oxides, in total up to a maximum amount of 1.0 wt %, wherein the glass ceramic cooking plate has a core and preferably has a gradient layer at the surface or towards the surface thereof, and wherein the core is arranged below the preferred gradient layer, wherein the glass ceramic cooking plate includes keatite mixed crystal (KMK) as the predominant crystal phase in the core and high-quartz mixed crystal (HQMK) as the predominant crystal phase in the preferred gradient layer, and wherein in a depth of 10 μm or more, the KMK crystal phase content exceeds 50% of the total of the HQMK and KMK crystal phase contents, wherein at a wavelength of 470 nm the maximum fraction of diffused light (“haze”) is at most 15%, preferably at most 12%, and/or in a range of wavelengths from 400 nm to 500 nm the maximum fraction of diffused light is at most 20%, preferably at most 17%, normalized to a glass ceramic cooking plate of 4 mm thickness in each case. Here again, a lower limit of 0.03 wt % for the amount of Fe₂O₃ may be advantageous for dyed glass ceramics.

In a preferred embodiment, the maximum haze at a wavelength of 630 nm is not more than 6%, preferably not more than 5%, most preferably not more than 4%, normalized to a glass ceramic cooking plate (11) of 4 mm thickness in each case.

Standards for the determination of the haze values as given above are 15014782 and ASTM D 1003, unless reference is made to further standards below.

The preferred glass ceramic material and the glass ceramic of the glass ceramic cooking plate obtained therefrom is preferably free of arsenic and free of antimony.

A preferred embodiment of the glass ceramic material and of the glass ceramic of the glass ceramic cooking plate obtained therefrom preferably contains tin.

Preferably, it may be contemplated in this case that the Li₂O content is between 3.0 and 4.2 percent by weight. Also, the TiO₂ content may preferably be limited to a range from 2.3 to 4.0 percent by weight. The Fe₂O₃ content is most preferably from 0.03 to 0.2 percent by weight.

The so produced glass ceramic cooking plate has a dark coloration in the visible wavelength range and at the same time exhibits low diffusion (haze). Therefore, displays can be arranged in known manner below the glass ceramic cooking plate and can be read from the upper surface thereof without scattering losses. Moreover, compared to known LAS glass ceramics that are dark colored in the visible range and not or only slightly diffusing, the glass ceramic cooking plate furthermore exhibits a transmittance which is increased in the infrared wavelength range, in particular in a wavelength range between 2900 nm and 4200 nm, which was hitherto only known for strongly diffusing glass ceramic cooking plates with a high fraction of the KMK phase. This high IR transmittance makes it possible to sense the temperature of a piece of cookware placed on the glass ceramic cooking plate in the region of the cooking zone, for example of a cooking pot, through the glass ceramic cooking plate, even at low temperatures and without contact, using the infrared sensor. The temperature of the cookware correlates sufficiently exactly with the temperature of a cooked food contained therein in order to enable automated cooking operation. During such automated cooking operation, the output power of a heater of the cooktop is closed-loop controlled as a function of the output measurement signal of the infrared sensor so as to adjust the desired temperature of the cooked food. Because of the high transparency of the glass ceramic cooking plate in the infrared range, sufficient heat radiation will pass through the glass ceramic cooking plate to the infrared sensor even in case of low temperatures of the cookware, such as for example during continued cooking, in order to enable to perform a reliable temperature measurement. Therefore, advantageously, no disturbing infrared sensors need to be arranged above the cooktop to face the cookware in order to allow for exact closed-loop control of the temperature of the cooked food.

In addition to the actual function of the infrared sensor, namely to enable automated cooking operation, the sensor is moreover able to detect faulty operation of the cooktop, for example in the case where cooking continues until the pot is empty or where it has been forgotten, and to reduce the output power of the appliance or turn it off and optionally initiate a warning signal for the user when a critical temperature is reached.

According to a particularly preferred embodiment variant of the invention, it may be contemplated that the glass ceramic cooking plate has a thickness in a range between 2.8 mm and 4.2 mm, preferably between 2.8 mm and 3.5 mm, most preferably between 2.8 mm and 3.2 mm. It has been found, surprisingly, that the glass ceramic cooking plate of the above-mentioned composition and the described layer structure has an increased strength as compared to known LAS glass ceramic cooking plates. Therefore it is possible to reduce the thickness of the glass ceramic cooking plate, which is usually 4 mm, while the relevant standard specifications (EN 60335, UL 858, CSA 22.2) in terms of the required impact strength of glass ceramic cooktops are still met. The reduced thickness of the glass ceramic cooking plate results in substantial improvements with respect to the control properties of the cooktop. First, with a reduced glass ceramic thickness the absorption losses in the infrared range decrease. As a result, the accuracy of non-contact temperature measurement using the infrared sensor can be improved, and hence the accuracy of closed-loop temperature control of the cooked food. At the same time, energy transfer by heat radiation from a heater to the cookware is improved. The thermal mass of the glass ceramic arranged between the heater and the placed cookware is reduced. Furthermore, the temperature difference and hence the temperature at the lower surface of the glass ceramic cooking plate required to transfer through the glass ceramic a specific amount of power via heat conduction, are reduced. As a result of both effects, a lower amount of heat needs to be introduced into the glass ceramic or dissipated therefrom when a change in the temperature of the cooked food is desired, which results in a faster control behavior. A further improvement of the control behavior results from the fact that in case of a thinner cooking plate a temperature change on the lower surface of the glass ceramic cooking plate has a faster effect on the temperature of the upper surface than in case of a thicker cooking plate. Thus, all these effects lead to improved controllability of the temperature of the cooked food during automatic cooking operation.

Furthermore, as a result of the reduced thickness of the glass ceramic energy loss is reduced since, on the one hand, the loss due to transverse heat conduction and storage within the glass ceramic cooking plate decreases proportionally to the saved thickness, and, on the other hand, the loss due to heat conduction, heat radiation, and convection is lower because of the lower temperatures at the lower surface of the glass ceramic. Thus, by using a thinner cooking plate, both the control behavior and the energy loss can be influenced positively.

A precise non-contact measurement of the temperature of a placed piece of cookware using an infrared sensor can be performed if, based on a thickness of 4 mm the glass ceramic cooking plate has a transmittance of greater than 5%, preferably greater than 7% at a wavelength of 3000 nm, and/or if it has a transmittance of greater than 18%, preferably greater than 24% at a wavelength of 3200 nm, and/or if it has a transmittance of greater than 37%, preferably greater than 43% at a wavelength of 3400 nm, and/or if it has a transmittance of greater than 51%, preferably greater than 54% at a wavelength of 3600 nm.

In order to enable a sensitive measurement of the heat radiation emitted by a piece of cookware and thus an accurate temperature measurement, the infrared sensor used need to be adapted to the emission spectrum of the cookware and to the transmission window of the glass ceramic cooking plate. This may be achieved by using an infrared sensor which has a spectral sensitivity in a range of wavelengths between 2800 nm and 4400 nm, preferably between 3400 nm and 4000 nm, most preferably at 3600 nm.

An accurate temperature measurement for pieces of cookware made of different materials can be made possible by adapting the electronics to take into account in the power control of the at least one heater an emission coefficient of a placed piece of cookware. The emission coefficient may be predefined in the electronics, for example to 1 for a black body or to any other value for a gray body. However, it may as well be contemplated that the emission coefficient is input by a user in dependence of a pot material used. This might be done, for example, by selecting a pot material from a predefined list.

In order to obtain a spatial separation between the infrared sensor and the heater so as to prevent overheating of the infrared sensor, it may be contemplated that the heat radiation of a placed piece of cookware is guided to the infrared sensor through a conductor of electromagnetic radiation. Such conductor may, for example, be a heat-resistant rod which is highly transparent in the infrared range, for example made of glass, or corresponding fibers. A portion of the heat radiation emanating from the cookware is introduced into the conductor at one end thereof, guided within the conductor by total internal reflection, and is emitted at the opposite end towards the infrared sensor.

Advantageously, it may be contemplated that the sensing area of the infrared sensor faces a bottom or a lateral surface of a placed piece of cookware. The temperature of both the bottom and the lateral surface do correlate well with the temperature of the cooked food, so that automated closed-loop control of the temperature of the cooked food is possible. In the case where the sensing area faces the lateral surface, the infrared sensor or the associated conductor for electromagnetic radiation will preferably be arranged at a corresponding angle, i.e. obliquely, below the glass ceramic cooking plate. With such an arrangement heat radiation is sensed which is emanating from the wall of the placed cooking vessel outside the cooking zone and therefore in the cold region and is transmitted through the glass ceramic cooking plate. Interference of the temperature measurement with heat radiation emitted by the glass ceramic cooking plate itself can thus be avoided.

Particularly preferably it may be contemplated that the glass ceramic cooking plate is provided with a smooth surface on both faces thereof. Due to the increased strength of the glass ceramic cooking plate, the usual knobbed pattern on the underside of the glass ceramic plate is no longer needed for increasing the strength. The smooth surface on both faces provides for better focusing of the measuring spot of the infrared sensor on the surface of the placed cookware and hence for a more precise measurement of the temperature thereof.

Rapid closed-loop control of the temperature of the cooked food may be achieved by having at least one radiation heater and/or halogen heater and/or induction heater arranged on a lower surface of the glass ceramic cooking plate, or by providing an electrical resistance heater as the at least one heater, in which case the conductor tracks of the resistance heater are connected to the glass ceramic cooking plate through an indirect or direct material bond.

Automated cooking operation is particularly desirable during continued cooking. During continued cooking, the cooked food is usually cooked over an elongated period of time at rather low temperatures. Accordingly, the temperature of the cookware and thus the emitted heat radiation will also be low. Due to the high transparency of the glass ceramic cooking plate in the infrared wavelength range, a measurable portion of heat radiation will nevertheless pass through the glass ceramic cooking plate to the infrared sensor even at low temperatures. In order to enable automated continued cooking, it may be contemplated that the infrared sensor and the electronics are designed for closed-loop control at a temperature of at least 90° C. and above, preferably at least 70° C. and above of the placed cookware.

An additional benefit of the temperature measurement can be achieved by the possibility of controlling an electrical appliance arranged outside the cooktop, in particular an exhaust hood, as a function of the signal of the infrared sensor. For example, the exhaust hood can be switched on when the cookware or cooked food reaches a certain temperature. Furthermore it is possible to automatically adjust the power setting of the exhaust hood as a function of the temperature of the cookware or cooked food.

In order to obtain a high strength of the glass ceramic cooking plate, for example in the area of a circumferential facet, it may be contemplated that the glass ceramic cooking plate has a reduced thickness in some areas and that the gradient layer is provided in and/or beyond the areas of reduced thickness.

A high strength of bent glass ceramic cooking plates can be achieved when the glass ceramic cooking plate is bent and/or three-dimensionally deformed and the gradient layer is provided in and/or beyond the bend and/or the three-dimensional deformation.

For the purpose of passing toggles or gas burners, bores may be provided in the glass ceramic cooking plate. Openings or cut-outs in the cooking plate may furthermore be provided for the guidance of exhaust and supply air or for the assembly of outlets. In these cases, such openings may have a circular, oval, or round corner shape. In order to again obtain enhanced strength of the glass ceramic cooking plate which allows to reduce the thickness thereof with the advantages mentioned before, it may be contemplated that the glass ceramic cooking plate has at least one opening, in particular a bore, and that the gradient layer is provided so as to extend right to the edge of the opening and/or that the gradient layer is provided on the wall of the opening. These measures result in increased edge strength of the bores. Bores can be arranged closer together or closer to the edge of the glass ceramic cooking plate, which provides new design options for the cooktop.

In order for displays and light-emitting elements to be clearly visualized, it may be contemplated that at a wavelength of 470 nm the maximum fraction of diffused light (“haze”) is not more than 15%, preferably not more than 12%, and/or that in a range of wavelengths from 400 nm to 500 nm the maximum fraction of diffused light is not more than 20%, preferably not more than 17%, normalized to a glass ceramic cooking plate of 4 mm thickness in each case. The fraction of diffused light is determined by determining, in an Ulbricht integrating sphere, the total intensity of diffused light for a sample, in this case a glass ceramic sample having a thickness of 4 mm, and comparing it to the original intensity of the output beam. Thus, the glass ceramic cooking plate of the cooktop according to the invention is in particular different from prior art glass ceramic cooking plates which have a high keatite mixed-crystal content and which appear to be translucent or even opaque, due to a large number of scattering centers, and which are therefore not suitable at least if displays are to be employed.

In order to prevent, for example, an irritating view to the technical components of the cooktop below the glass ceramic cooking plate and to avoid glaring effects caused by radiating heaters, in particular bright halogen heaters, it may be contemplated that, normalized to a glass ceramic cooking plate of 4 mm thickness in each case, light transmittance according to DIN EN 410, 1998 in a range of wavelengths from 380 nm to 780 nm, determined for standard illuminant D 65, is less than or equal to 5%, and that at a wavelength of 420 nm spectral transmittance according to DIN 5036-1, 1978-07, determined in a measurement method according to DIN EN 410, 1998 or ISO 15368, 2001-08, is preferably greater than 0.2%. With such adjusted transmittance the glass ceramic cooking plate will have a black appearance under incident light. However, displays and light-emitting elements arranged below the glass ceramic cooking plate are easily visible and readable through the glass ceramic. Also, heaters in operation can be perceived in sufficient brightness.

It is furthermore possible to use the glass ceramic plate for a number of other devices in which the heat transfer in combination with improved sensor technology can be advantageously exploited. For example, the glass ceramic can be used as a soleplate in an flat iron, or as a separating member in a toaster in which case the glass ceramic plate is arranged between the heater and a utility space of the toaster, or the glass ceramic may be designed as a cover for a heater. It is furthermore possible to use such glass ceramics as a cover for gas burners in a gas stove, or as a baking tray.

### BRIEF DESCRIPTION OF THE DRAWINGS

The invention will be described in more detail below by way of exemplary embodiments and with reference to the accompanying drawings. In the figures, the same reference numerals denote the same or equivalent elements. In the figures:

FIG. 1 is a first diagram with transmittance curves of two prior art glass ceramics;

FIG. 2 is a second diagram with transmittance curves of one prior art and one glass ceramic cooking plate according to the invention, and with power curves of heat radiation emitted by a black body;

FIG. 3 shows a section of a cooktop comprising a glass ceramic cooking plate and an infrared sensor;

FIG. 4 shows the cooktop illustrated in FIG. 3 with an alternative arrangement of the infrared sensor;

FIG. 5 shows the cooktop illustrated in FIGS. 3 and 4 with yet another arrangement of the infrared sensor;

FIG. 6 is a third diagram illustrating an overshoot behavior during boiling-up of water as the cooked food;

FIG. 7 is a fourth diagram illustrating determination of the boil-up time for water as the cooked food;

FIG. 8 is a fifth diagram illustrating the cooling behavior of glass ceramic cooking plates;

FIG. 9 shows a side view of an edge of a glass ceramic cooking plate with a facet provided thereon; and

FIG. 10 shows a side view of a bent glass ceramic cooking plate.

### DETAILED DESCRIPTION

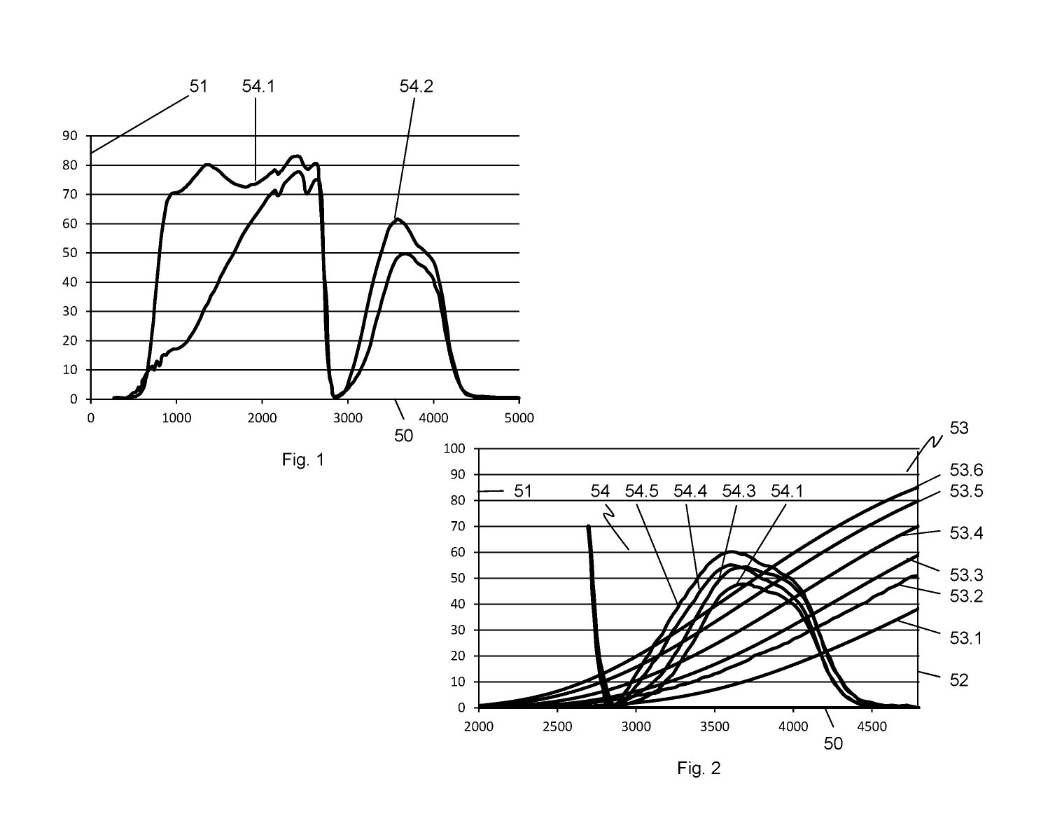

FIG. 1 shows a first diagram with transmittance curves 54.1, 54.2 of two prior art glass ceramics. For this purpose, a wavelength in nm is plotted along an x-axis (50), and a transmittance in percent is plotted along a y-axis (51).

Both transmittance curves 54.1, 54.2 apply to glass ceramics with a thickness of 4 mm. The first transmittance curve 54.1 represents a first LAS glass ceramic, which is dyed and transparent in the visible range and includes high-quartz mixed crystals (HQMK) as the main crystal phase, such as marketed, e.g., under the trade name CERAN HIGHTRANS®. The second transmittance curve 54.2 was determined on a second, white glass ceramic that is opaque or translucent in the visible range and includes keatite mixed crystals (KMK) as the main crystal phase. Such a glass ceramic is known, for example, under the trade name CERAN ARTICFIRE®.

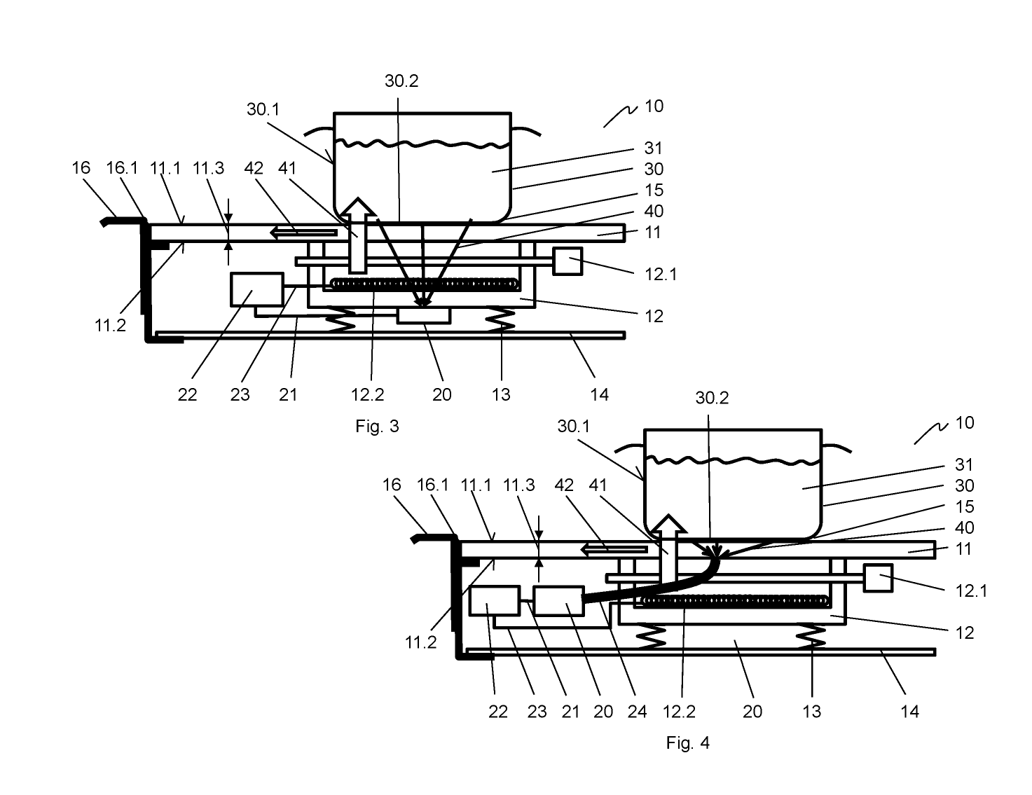

In a range of wavelengths between approximately 3000 nm and 4500 nm, the second glass ceramic which is opaque in the visible range exhibits a higher transparency than the first glass ceramic which is transparent in the visible range. Such a high transparency in the IR range allows for a contactless optical temperature measurement on a piece of cookware 30 placed on the second glass ceramic as shown in FIGS. 3 to 5, through the glass ceramic. This is advantageously performed using a suitable infrared sensor 20 which is also described in more detail with reference to in FIGS. 3 to 5. With such a temperature measurement, an automated cooking operation can be performed. By contrast, the transparency of the first glass ceramic is not sufficient in the range between 3000 nm and 4500 nm to allow for a sufficiently accurate temperature measurement even at low temperatures of the cookware.

Thus, with prior art glass ceramics as currently used for glass ceramic cooktops 11 shown in FIGS. 3-5 it is not possible to simultaneously provide a non-diffusing, dark colored and transparent glass ceramic cooking plate 11 which provides for visibility of display elements arranged below the glass ceramic and at the same time allows for an accurate non-contact temperature measurement by means of an infrared sensor and thus automated control of the cooking zone.

FIG. 2 shows a second diagram with transmittance curves 54 of one prior art and one glass ceramic cooking plate 11 according to the invention, and power curves 53 of heat radiation emitted by a black body at different temperatures.

The transmittance curves 54 are plotted with respect to x axis 50 and y-axis 51, the power curves 53 are plotted with respect to x-axis 50 and a second y-axis 52. X-axis 50 represents a wavelength in nm, y-axis 51 a transmittance in percent, and the second y-axis 52 represents a radiation power per wavelength range.

The first transmittance curve 54.1 corresponds to a known first LAS glass ceramic of 4 mm thickness which is dark colored in the visible wavelength range and not diffusing, as already shown in FIG. 1. The third transmittance curve 54.3 shows the transmission behavior of the known first glass ceramic in case of a thickness reduced to 3.2 mm. A fourth transmittance curve 54.4 was measured on a glass ceramic cooking plate 11 according to the invention with a thickness 11.3 as shown in FIGS. 3 to 5 of 4 mm, while a fifth transmittance curve 54.5 represents the wavelength-dependent transmittance of the glass ceramic cooking plate 11 according to the invention with a thickness 11.3 of 3.2 mm.

The glass ceramic cooking plate 11 according to the invention has the following composition, given in percent by weight:

| | |
|---|---|
| Al₂O₃ | 18-23 |
| Li₂O | 2.5-4.2 |
| SiO₂ | 60-69 |
| ZnO | 0-2 |
| Na₂O + K₂O | 0.2-1.5 |
| MgO | 0-1.5 |
| CaO + SrO + BaO | 0-4 |
| B₂O₃ | 0-2 |
| TiO₂ | 2.3-4.5 |
| ZrO₂ | 0.5-2 |
| P₂O₅ | 0-3 |
| SnO₂ | 0-<0.6 |
| Sb₂O₃ | 0-1.5 |
| As₂O₃ | 0-1.5 |
| TiO₂ + ZrO₂ + SnO₂ | 3.8-6 |
| V₂O₅ | 0.01-0.08 |
| Fe₂O₃ | 0.008-0.3. |

In addition, further coloring oxides may be contained in an amount of up to at most 1.0 wt %. In this case, the Li₂O content is preferably limited to a range from 3.0 to 4.2 wt %, the TiO₂ content is preferably limited to a range from 2.3 to 4.0 wt %, and the Fe₂O₃ content to a range from 0.03 to 0.2 wt %.

The preferred glass ceramic material and the glass ceramic of the glass ceramic cooking plate made therefrom is preferably free of arsenic and free of antimony.

The preferred glass ceramic material and the glass ceramic of the glass ceramic cooking plate made therefrom preferably contains tin.

For producing the glass ceramic cooking plate 11 according to the invention, first a green glass of the aforementioned composition is melted, then shaped into the desired plate shape and appropriately cut. During a subsequent ceramization process, a pre-crystallized glass ceramic intermediate product is produced, with a high-quartz mixed crystal (HQMK) as the predominant crystal phase. By a further crystal conversion step, the HQMK phase is partially converted into a keatite mixed crystal phase. This conversion step takes place at a maximum temperature Tₘₐₓ which is maintained for a predetermined holding time t(Tₘₐₓ). Suitable holding times and maximum temperatures are given by a temperature-time range which is limited by four straight lines. In the present case, the straight lines connect vertices of the temperature-time range with the values pairs (Tₘₐₓ=910° C.; t(Tₘₐₓ)=25 minutes), (Tₘₐₓ=960° C.; t(Tₘₐₓ)=1 minute), (Tₘₐₓ=980° C.; t(Tₘₐₓ)=1 minute), and (Tₘₐₓ=965° C.; t(Tₘₐₓ)=25 minutes).

With the composition and the production process described above, a glass ceramic cooking plate 11 is obtained which comprises a gradient layer 11.4 and an underlying core 11.5, as illustrated in FIGS. 9 and 10. The core 11.5 includes keatite mixed crystal (KMK) as the predominant crystal phase. The gradient layer 11.4 includes high-quartz mixed crystal (HQMK) as the predominant crystal phase. Starting from the surface of the glass ceramic cooking plate 11, the KMK crystal phase content exceeds 50% of the total of the HQMK and KMK crystal phase contents in a depth of 10 μm or more. Preferably, an amorphous layer is additionally disposed above the gradient layer.

The so produced glass ceramic cooking plate 11 exhibits increased strength as compared to prior art LAS-based glass ceramic cooking plates 11 of the same thickness 11.3, and a suitable coloration in the visible wavelength range with at the same time low diffusion (haze). As can be seen from a comparison of the fourth transmittance curve 54.4 with the first transmittance curve 54.1 for glass ceramic cooking plates 11 of 4 mm thickness and from a comparison of the fifth transmittance curve 54.5 with the third transmittance curve 54.3, the glass ceramic cooking plate 11 according to the invention exhibits significantly higher transparency in a wavelength range between 2800 nm and 4600 nm than the prior art first glass ceramic. In the visible range, not illustrated, both types of glass ceramics have comparable properties in terms of coloration, transparency, and diffusion.

The power curves 53 show the radiation power of a black body related to a respective wavelength range, at different temperatures. The black body is representative of a piece of cookware 30 placed on a glass ceramic cooking plate 11, as shown in FIGS. 3 to 5. For example a piece of cookware 30 made from a cast iron material has approximately the radiation characteristics of a black body. A first power curve 53.1 shows the wavelength-dependent profile of the radiation power of the black body at a temperature of 70° C. Similarly, a second power curve 53.2 shows the profile at 100° C., a third power curve 53.3 shows the profile at 120° C., a fourth power curve 53.4 shows the profile at 150° C., a fifth power curve 53.5 shows the curve at 180° C., and a sixth power curve 53.6 shows the profile at 200° C.

FIG. 3 shows a detail of a cooktop 10 with a glass ceramic cooking plate 11 and an infrared sensor 20.

A heater 12, which is in the form of a radiant heater in the present exemplary embodiment, is urged against a lower surface 11.2 of glass ceramic cooking plate 11 by means of spring elements 13 bearing against a bottom 14 of the cooktop. Heater 12 comprises a heating coil 12.2 and a protective temperature limiter 12.1. Protective temperature limiter 12.1 interrupts the power supply to the heating coil 12.2 when the temperature of the glass ceramic cooking plate 11 exceeds a predetermined threshold value. The heater 12 defines a hot zone which is marked as a cooking zone 15 on an upper surface 11.1 of glass ceramic cooking plate 11. The piece of cookware 30 in the form of a pot in the present example has a bottom 30.2 which is placed on glass ceramic cooking plate 11 in the area of cooking zone 15. The piece of cookware 30 is partially filled with food to be cooked 31, in the illustrated exemplary embodiment with water. The wall of cookware 30 defines an outer circumferential lateral surface 30.1. The cookware 30 and the food to be cooked 31 contained therein is heated by heater 12, symbolized by energy flow 41 as illustrated. Energy flow 41 is primarily composed of radiation energy emitted by heating coil 12.2 and of energy transferred by heat conduction in the region of glass ceramic cooking plate 11. The energy transfer from heater 12 to cookware 30 is subject to energy loss 42, as illustrated herein by the example of transverse heat conduction within glass ceramic cooking plate 11. Glass ceramic cooking plate 11 has a thickness 11.3 marked by a double arrow, and in the present example it is glued into a frame 16 of cooktop 10 by means of a flexible adhesive 16.1. Frame 16 is connected to the bottom 14 of the cooktop.

Infrared sensor 20 is arranged within cooktop 10 and below heater 12. A sensing area of infrared sensor 20 is facing, through a corresponding recess in a heater base and through glass ceramic cooking plate 11, the region of cooking zone 15. Heat radiation 40 emanating from the bottom 30.2 of the piece of cookware 30 placed in cooking zone 15 can thus reach the infrared sensor 20. Not illustrated, it may be contemplated that the heat radiation 40 from cookware 30 is guided to the infrared sensor 20 within a region shielded towards the surrounding area. Interference from background radiation can be avoided in this way.

Infrared sensor 20 is connected to electronics 22 via a signal line 21. Electronics 22 power the heater 12 with electrical energy via a cable connection 23.

In cooking operation, cookware 30 is heated. As a result, the power of the heat radiation 40 emitted by cookware 30 increases, as shown in FIG. 2 by power curves 53, according to Planck's radiation law for a black body. The heat radiation 40 is received by infrared sensor 20 and converted into a preferably proportional measurement signal. This measurement signal is passed through the signal line to electronics 22. Electronics 22 control the power output to the heater 12 so that a desired temperature of the bottom 30.2 of cookware 30 is adjusted. Because of the good heat conduction properties of the materials used for cookware 30, the temperature of cookware 30 correlates well with that of the cooked food 31 contained therein. The arrangement thus permits to provide a control circuit in which a desired temperature of the cooked food 31 can be closed-loop controlled automatically.

The employed infrared sensor 20 has its greatest sensitivity in a range of wavelengths between 2800 nm and 3200 nm. In this wavelength range, the power of the heat radiation emitted by cookware 30 at low temperatures is still very small, as shown by the power curves 53 illustrated in FIG. 2. If the glass ceramic cooking plate 11 is made of the prior art first glass ceramic with a thickness 11.3 of 4 mm, the glass ceramic cooking plate 11 exhibits high absorption in the sensing range of the infrared sensor 20, as illustrated by the associated first transmittance curve 54.1 in FIG. 2. So a high proportion of the already low heat radiation 40 emitted by cookware 30 will be absorbed. Therefore, measurement of the temperature of cookware 30 and hence of the cooked food 31 is not possible when the prior art first glass ceramic is employed. A reduction of the thickness 11.3 of glass ceramic cooking plate 11 to 3.2 mm leads to an improvement, as can be seen from the third transmittance curve 54.3. However, a glass ceramic cooking plate 11 made of a prior art glass ceramic material and with this reduced thickness 11.3 does not meet the requirements according to the relevant standards (e.g. EN 60335, UL 858, CSA 22.2) with respect to the necessary impact strength.

As shown in FIG. 2 by the fourth transmittance curve 54.4, the glass ceramic cooking plate 11 according to the invention exhibits significantly improved transmittance within the range of maximum sensitivity of the employed infrared sensor 20 as compared to the prior art glass ceramic. Therefore, with such a glass ceramic cooking plate 11 according to the invention, a sufficient quantity of heat radiation 40 from cookware 30 will reach the infrared sensor 20, even in case of a thickness 11.3 of the glass ceramic cooking plates 11 of 4 mm and with low temperatures of the cookware 30, so that exact and reliable temperature control is made possible. According to the invention, the response behavior of infrared sensor 20 may further be improved by reducing the thickness 11.3 of the glass ceramic cooking plate 11 according to the invention to 3.2 mm, as shown in the exemplary embodiment. This is illustrated by the fifth transmittance curve 54.5 in FIG. 2. Because of the increased strength of the glass ceramic cooking plate 11 of the invention, it satisfies the requirements in terms of the impact strength to be achieved even with a thickness 11.3 of 3.2 mm.

The glass ceramic cooking plate 11 according to the invention permits to perform a non-contact temperature measurement on cookware 30 placed on the glass ceramic cooking plate 11, with high accuracy and sensitivity in the infrared range between approximately 3000 nm and 4500 nm. At the same time, the aesthetic appearance of a dark colored non-diffusing glass ceramic cooking plate 11 is maintained. On the one hand, this permits to arrange displays below the glass ceramic cooking plate 11 in known manner. On the other hand, automated cooking operation is made possible. The latter is even made possible for the particularly interesting temperature range of continued cooking. During continued cooking, the cooked food 31 is cooked at comparatively low temperatures. The temperatures of the cookware 30 that are to be detected by the infrared sensor 20 are in a range from 70° C. to 150° C. in this case. As shown by the first power curve 53.1, the power of the emitted heat radiation 40 is very low for a cooking vessel temperature of 70° C. in the wavelength range in which the infrared sensor 20 has its highest sensitivity. However, when using a glass ceramic cooking plate 11 according to the invention with a thickness 11.3 reduced to 3.2 mm, the heat radiation 40 radiated to the infrared sensor 20 is sufficient to obtain a reliable and reproducible measurement signal.

FIG. 4 shows the cooktop 10 as illustrated in FIG. 3, but with an alternative arrangement of infrared sensor 20. Infrared sensor 20 is arranged inside cooktop 10 laterally to the heater 12. A conductor 24 of electromagnetic radiation extends from the infrared sensor 20 to the lower surface 11.2 of glass ceramic cooking plate 11. At the end of glass ceramic cooking plate 11, the conductor 24 is oriented so that an inlet face for the heat radiation 40 is arranged directly upon or slightly spaced from the lower surface 11.2 of glass ceramic cooking plate 11. Thus, heat radiation 40 emanating from the bottom 30.1 of the cookware 30 will pass through the glass ceramic cooking plate 11 and the inlet face into the conductor 24. Conductor 24 is designed so that the heat radiation 40 is guided within the conductor 24 by total internal reflection. For this purpose, the conductor 24 is made of a material which is highly transparent to infrared radiation. Like in the illustrated embodiment, conductor 24 may be rod-shaped or in the form of optical fibers. Infrared sensor 20 measures the received heat radiation 40 and generates the measurement signal therefrom, which is forwarded to the electronics. Thus, closed-loop control of the cooking process can take place as described in conjunction with FIG. 3. An advantage of the arrangement is that the infrared sensor 20 can be arranged at a distance from the heater 12. In this way, damage to the infrared sensor 20 due to excessively high temperatures can be avoided.

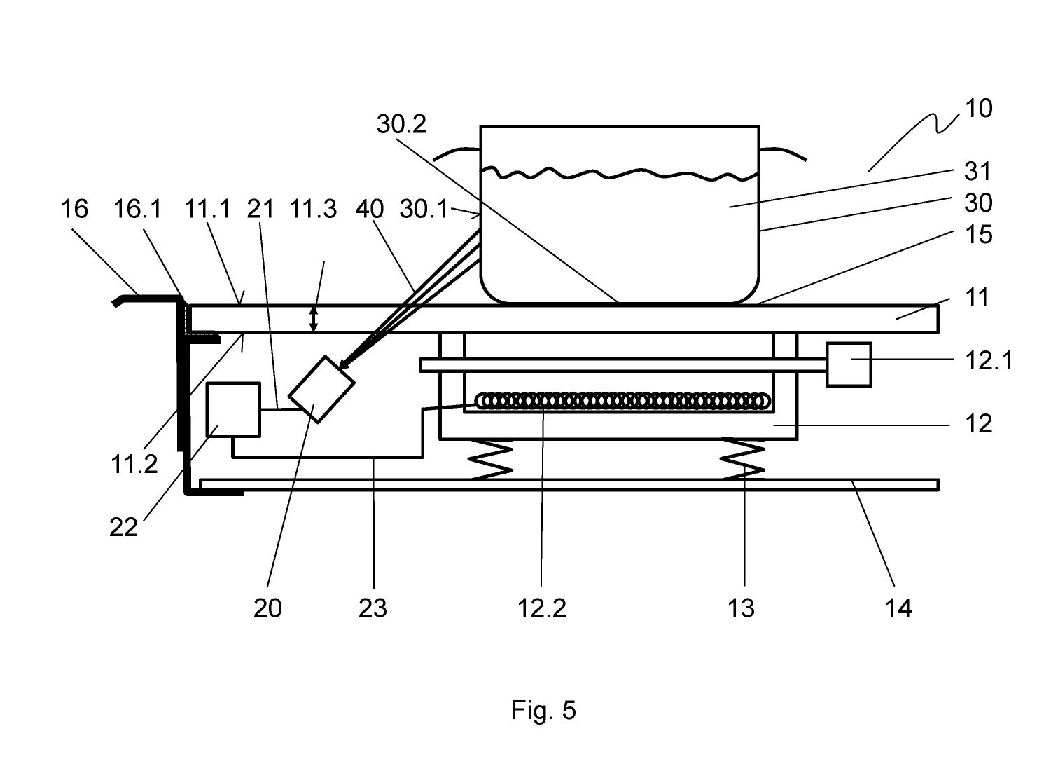

FIG. 5 shows the cooktop 10 as illustrated in FIGS. 3 and 4, but with another arrangement of infrared sensor 20. Again, the infrared sensor 20 is arranged inside cooktop 10 laterally to the heater 12. The sensing direction of the infrared sensor 20 is oriented obliquely through the glass ceramic cooking plate 11 towards the area of cooking zone 15 and thus to the lateral surface 30.1 of the placed piece of cookware 30. Thus, heat radiation 40 emanating from lateral surface 30.1 can thus be captured by infrared sensor 20 and used for controlling the temperature of the piece of cookware 30 or the cooked food 31. Due to the oblique orientation of the infrared sensor 20, the optical path length of the heat radiation 40 to be evaluated is comparatively long within glass ceramic cooking plate 11. However, because of the high transparency of the glass ceramic according to the invention and the reduced thickness of glass ceramic cooking plate 11, a sufficiently large portion of the heat radiation emitted from lateral surface 30.1 will nevertheless reach the infrared sensor 20 to enable a reliable temperature measurement even in case of low temperatures of the cookware 30. Advantageously, the infrared sensor 20 is again arranged at a distance from heater 12 in this arrangement, so that damage to the infrared sensor 20 due to excessive heat can be avoided. Another advantage of the arrangement is that the temperature of lateral surface 30.1 is determined, which in certain cooking situations exhibits better correlation with the temperature of the cooked food 31 than the temperature of the bottom 30.2 of the cookware 30. A further advantage is that the sensing is effected through a comparatively cold region of the glass ceramic cooking plate 11. Thus, corruption of the measurement due to background radiation, for example from heater 12 or from the heated glass ceramic cooking plate 11, can be avoided.

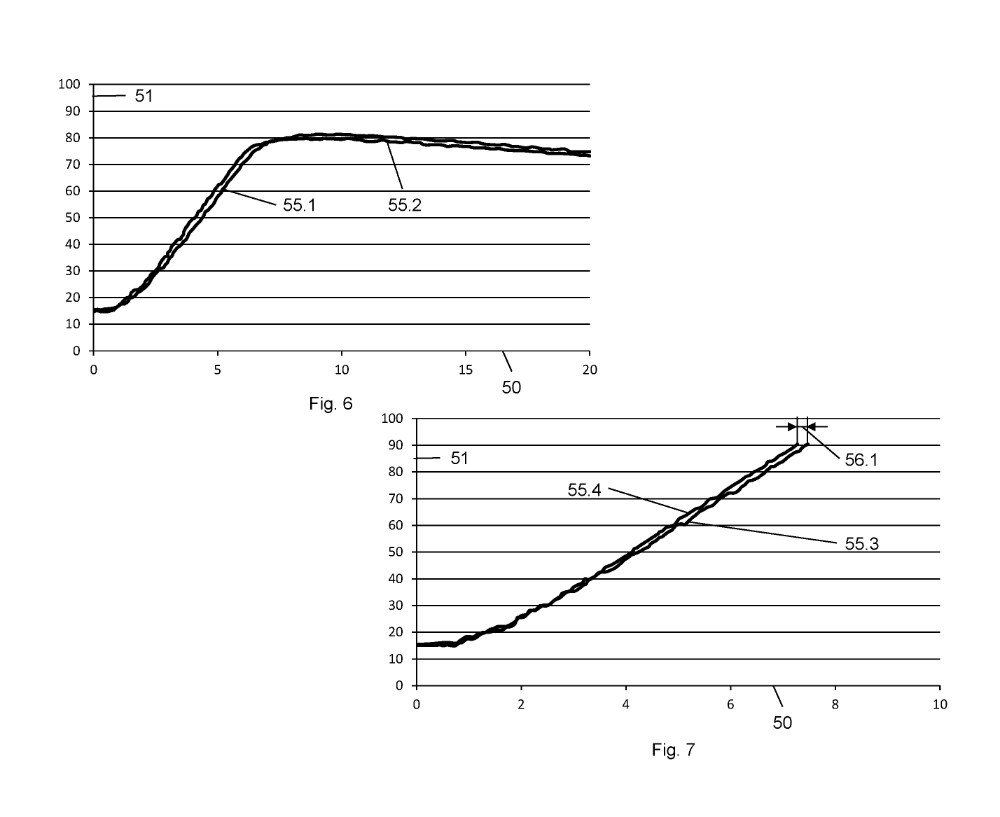

FIG. 6 shows a third diagram illustrating an overshoot behavior during boiling-up of water as the cooked food 31, as determined according to standard DIN EN 60350-2. The x-axis 50 represents time in minutes, while the y-axis 51 represents a temperature of the cooked food 31 in degrees Celsius. A first temperature curve 55.1 was measured on a prior art glass ceramic cooking plate 11 of 4 mm thickness, while a second temperature curve 55.2 was determined on a glass ceramic cooking plate 11 according to the invention with a thickness 11.3 of 3.2 mm.

In the experiment, 1.5 kg of water are heated, starting from a temperature of 15° C. When a water temperature of 70° C. is reached, the heater 12 is switched off. The overshoot temperature is evaluated, that means the difference between the maximum temperature reached and the switch-off temperature of 70° C. As the comparison of the two temperature curves 55.1, 55.2 shows, the water temperature overshoots 15% less when the thinner glass ceramic cooking plate 11 of the invention is used compared to when using a prior art glass ceramic cooking plate 11 of 4 mm thickness. This has a corresponding positive effect on the control behavior during a regular cooking operation, since a desired temperature of the cooked food can be adjusted more quickly and accurately.

FIG. 7 shows a fourth diagram illustrating determination of the boil-up time for water as the cooked food 31. Here, again, the test procedure is performed according to DIN EN 60350-2. Accordingly, 1.5 kg of water are heated, starting at 15° C., and the time until a water temperature of 90° C. is reached is determined.

The x-axis 50 represents time in minutes, while the y-axis 51 represents the temperature of the water in degrees Celsius. A third temperature curve 55.3 represents the temperature profile when a prior art glass ceramic cooking plate 11 of 4 mm thickness is used. A fourth temperature curve 55.4 is accordingly captured with a glass ceramic cooking plate 11 according to the invention with a thickness 11.3 of 3.2 mm. As can be seen from the indicated first saved time 56.1, the boil-up time can be improved when the novel glass ceramic cooking plate 11 is used. This also has an advantageous effect on the control behavior of the cooktop during cooking operation, in particular when a temperature change is desired. As a result of the shorter boil-up times, energy consumption for boiling-up is also reduced.

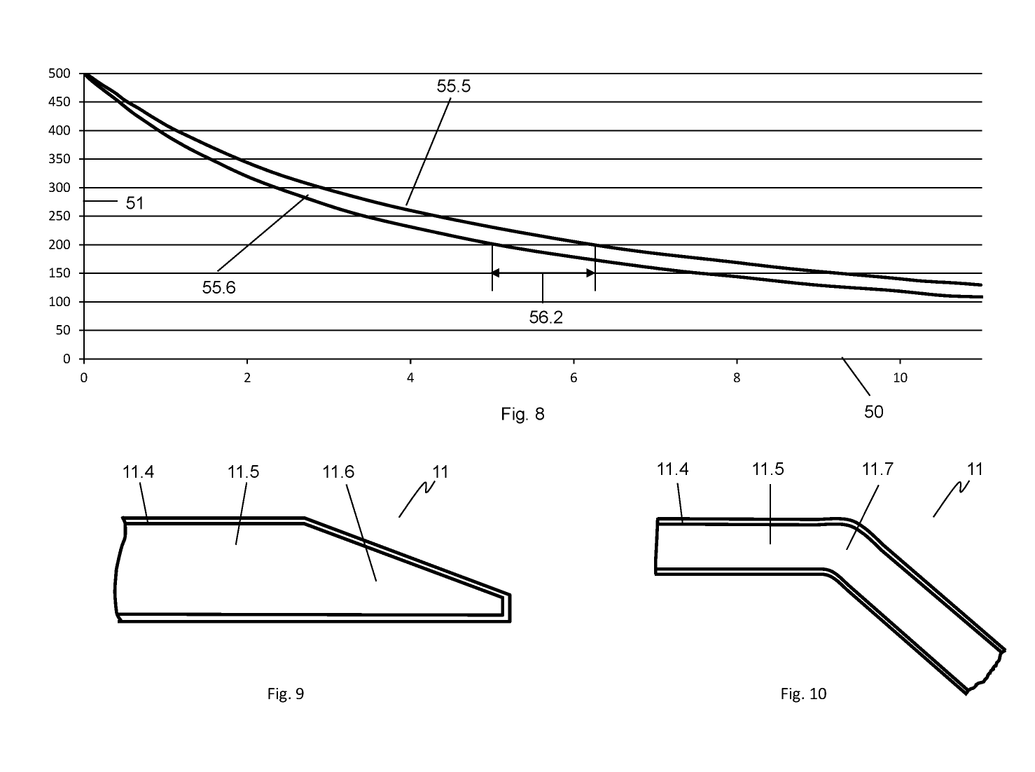

FIG. 8 shows a fifth diagram illustrating the cooling behavior of glass ceramic cooking plates 11, starting from an initial temperature of 500° C. A fifth temperature curve 55.5 and a sixth temperature curve 55.6 are plotted with respect to the y-axis 51 representing temperature in degrees Celsius and to the x-axis 50 representing time in minutes. The fifth temperature curve 55.5 shows the cooling behavior of a prior art glass ceramic cooking plate 11 of 4 mm thickness, while the sixth temperature curve 55.6 represents the cooling behavior of a glass ceramic cooking plate 11 according to the invention with a thickness 11.3 of 3.2 mm. Second saved time 56.2 marks the time difference in the cooling behavior of the two glass ceramic cooking plates 11 until a temperature of 200° C. is reached. Here, again, the significantly faster response of the novel glass ceramic cooking plate of the invention with 3.2 mm material thickness is evident, whereby a further improvement in controllability of the temperature of a cooked food 31 is achieved.

In summary, due to its improved transmittance characteristics in the infrared range the glass ceramic cooking plate 11 according to the invention provides for automated cooking operation using infrared sensor 20. In particular in the case of glass ceramic cooking plates 11 with a thickness 11.3 reduced to 3.2 mm it is possible to sense even low temperatures of a piece of cookware 30. This allows for controlled operation for instance during continued cooking, during which the temperatures of the cookware 30 are in a range from 70 to 150° C. At the same time, the appearance of a dark colored transparent glass ceramic is preserved. Display elements may still be arranged below the glass ceramic cooking plate 11. The valid specifications regarding impact strength of glass ceramic cooktops 11 are met even with a reduced thickness 11.3 of the glass ceramic cooking plate 11 of 3.2 mm.

FIG. 9 shows a side view of an edge of a glass ceramic cooking plate 11 with a facet 11.6 provided thereon. According to the invention, the glass ceramic cooking plate 11 has a core 11.5 with an elevated KMK phase content, and a gradient layer 11.4 with an elevated HQMK content. For the sake of better illustration, the gradient layer 11.4 which in reality only has a thickness of about 10 μm, is shown enlarged relative to the core 11.5, and an overlying amorphous layer is not shown. Advantageously, gradient layer 11.4 and core 11.5 continue into the facet region 11.6 of the glass ceramic cooking plate 11 which has a reduced thickness 11.3. Therefore, the increased strength of the inventive glass ceramic cooking plate 11 also has a positive effect in the facet region 11.6 which is particularly fragile due to its location on the outer edge of the glass ceramic cooking plate 11 and its reduced thickness 11.3.

FIG. 10 shows a side view of a bent glass ceramic cooking plate 11. Bend 11.7 extends perpendicularly to the drawing plane. As the figure shows, core 11.5 and gradient layer 11.4 continue into the region of bend 11.7 and have a strength-increasing effect there.

For the described glass ceramic according to one embodiment of the invention, the boil-up behavior when using a radiant heater can also be characterized in comparison to a conventional glass ceramic of 4 mm thickness by determining the boil-up time, i.e. the time required until a predefined temperature of the cooked food, the control temperature, is reached, starting from an initial temperature. In the present case, the initial temperature of the cooked food is 15° C., the control temperature is 70° C. With the glass ceramic according to one embodiment of the invention, the boil-up time can be reduced by up to 5%.

If the heating of water from 15° C. to 90° C. using a radiant heater is considered, improvements in heating behavior are obtained as well. The boil-up time for a cooktop according to an embodiment of the invention decreases by up to 4%, for example. Energy consumption can be reduced by up to 3.3% compared to a cooktop equipped with a glass ceramic of 4 mm thickness.

Furthermore, when using a glass ceramic plate of 3 mm thickness according to an embodiment of the invention, so-called faulty cooking behavior, i.e. cooking with an empty pot, can be detected easier. Since such faulty cooking behavior may moreover cause overheating of a cooktop, the improved detectability of such faulty cooking behavior for cooktops according to embodiments of the present invention thus provides improved safety.

In order to check for faulty cooking behavior, e.g. empty pot, in laboratory, test series are carried out with an induction appliance and special metal rings. These test series show that a reduction in thickness by 25% results in a 10% faster switch-off of the cooking zone power.

They are thus particularly suitable for so-called “automated cooking” which is sensor-controlled, for example.

Furthermore, the thickness of the glass ceramic used in a cooktop has an influence on energy consumption. Below, this will be illustrated by way of example for a cooktop which on the one hand is equipped with a glass ceramic plate of 4 mm thickness, and on the other hand has a glass ceramic plate of only 3 mm thickness according to an embodiment of the invention.

The calculation below is made for a cooking zone having a diameter of 32 cm. During boiling-up, the temperature of the glass ceramic increases by 500° C., as was shown by measurements in which the temperature of the glass ceramic upper surface was determined. The energy E required for this temperature increase of 500° C. or 500 K (ΔT=500 K) is obtained according to the following equation:

E=m·c_{P}·ΔT,

wherein m is the mass of the heated region, and cₚ is the specific heat capacity of the glass ceramic. Mass m is obtained from the density p of the glass ceramic, which is 2.6 g/cm³, by multiplication with the size of the heated volume of the glass ceramic, the heated volume corresponding to a cylinder with a base area π·r², with r=16 cm, and with a thickness d of 0.4 cm or 0.3 cm.

Accordingly, for the case of a glass ceramic of 4 mm thickness the energy required for boiling-up is calculated to be 334.567 kJ, or 92.94 Wh. For the case of a glass ceramic of 3 mm thickness, the energy required for boiling-up is 250.925 kJ, or 69.7 Wh. Thus, the energy required for boiling-up is reduced by 25%, or in the specific case by 23.24 Wh.

If instead of the heating of only the glass ceramic the entire cooking process is considered, that means including the heating of the cooked food and continued boiling, the 23.24 Wh can be subtracted from the determined energy consumption for a cooktop equipped with a glass ceramic plate of 4 mm thickness. Values for a specific heater are listed in the following table, by way of example.

TABLE 1

| | Energy consumption | Energy consumption |
|---|---|---|
| Heater | [Wh] | [Wh/kg] |
| E.G.O. 320 mm/4200 W | 912.7 | 177.6 |
| glass ceramic of | | |
| 4 mm thickness | | |
| E.G.O. 320 mm/4200 W | 889.5 | 173.0 |
| glass ceramic of | | |
| 3 mm thickness | | |

For the considered heater, in the present example a radiant heater with a power of 4200 W and a diameter of 320 mm, a reduction in energy consumption by 2.5% is achieved over the entire cooking process.

In the context of the present invention, ‘energy consumption’ refers to the energy required for a process. Therefore, in the above table the ‘energy consumption’ of a cooktop comprising a glass ceramic plate of 4 mm thickness is the energy that must be applied for the cooking process considered here, that is to say boiling-up and continued cooking for 20 minute. The terms of ‘energy’ and ‘energy consumption’ are therefore used largely synonymously in the context of the present application.

The energy consumption which is reduced because a thinner glass ceramic plate is employed, is important in particular because the cooking process as a whole becomes more efficient in this very simple manner. This in turn means that future threshold values for instance for cooktops, such as specified in EU regulation 66/2014 of the commission of Jan. 14, 2014, for example, can be easily undershot or met with regard to energy efficiency without requiring any adaptation of the heating.

Moreover, a reduction in transverse heat conduction is resulting due to the reduction in thickness. Transverse heat conduction refers to the transferred amount of heat Q which is dissipated laterally through the non-heated regions of the glass ceramic plate and is calculated according to the following formula:

Q=(λ·A·t·ΔT)/l,

wherein l is the distance between the cooking zone and a corner of the cooking plate and is 0.025 m, ΔT is the temperature difference between the hot area and the edge of the cooking plate and is approximately 400 K, t is the cooking time and is assumed to be 30 minutes here. Thermal conductivity λ is 1.6 W/mK. Finally, A is the cross-sectional area and is calculated to be 1.6*10⁻⁵ m² for a glass ceramic of 4 mm thickness and 1.2*10⁻⁶ m² for a glass ceramic of 3 mm thickness.

With these figures, the transferred amounts of heat are calculated to be 737.28 J in the case of a glass ceramic of 4 mm thickness and 552.96 J in the case of the glass ceramic of 3 mm thickness. This gives a 25% reduction in the transferred amount of heat Q for a 25% reduction in thickness.

It will be obvious from the above that cooktops according to embodiments of the invention, overall, provide improved controllability. For the purposes of the present invention, controllability refers to the control of the cooking process in particular so that a specific temperature of the cooked food is achieved. Improved controllability is in particular given when less time is required between the definition of a target value, for example a temperature, and the time this target value is reached. Moreover, such improved controllability is however also given when certain secondary effects are improved. In particular, improved controllability is therefore also given if, overall, less energy has to be applied to achieve a certain effect, for example for adjusting a specific target temperature of the cooked food, or if overall energy loss is minimized.

LIST OF REFERENCE NUMERALS

| | |
|---|---|
| 10 | Cooktop |
| 11 | Glass ceramic cooking plate |
| 11.1 | Upper surface |
| 11.2 | Lower surface |
| 11.3 | Thickness |
| 11.4 | Gradient layer |
| 11.5 | Core |
| 11.6 | Facet |
| 11.7 | Bend |
| 12 | Heater |
| 12.1 | Protective temperature limiter |
| 12.2 | Heating coil |
| 13 | Spring element |
| 14 | Bottom of cooktop |
| 15 | Cooking zone |
| 16 | Frame |
| 16.1 | Adhesive |
| 20 | Infrared sensor |
| 21 | Signal line |
| 22 | Electronics |
| 23 | Cable connection |
| 24 | Conductor |
| 30 | Cookware |
| 30.1 | Lateral surface |
| 30.2 | Bottom |
| 31 | Food to be cooked |
| 40 | Heat radiation |
| 41 | Energy flow |
| 42 | Energy loss |
| 50 | x-axis |
| 51 | y-axis |
| 52 | Second y-axis |
| 53 | Power curves |
| 53.1 | First power curve |
| 53.2 | Second power curve |
| 53.3 | Third power curve |
| 53.4 | Fourth power curve |
| 53.5 | Fifth power curve |
| 53.6 | Sixth power curve |
| 54 | Transmittance curves |
| 54.1 | First transmittance curve |
| 54.2 | Second transmittance curve |
| 54.3 | Third transmittance curve |
| 54.4 | Fourth transmittance curve |
| 54.5 | Fifth transmittance curve |
| 55.1 | First temperature curve |
| 55.2 | Second temperature curve |
| 55.3 | Third temperature curve |
| 55.4 | Fourth temperature curve |
| 55.5 | Fifth temperature curve |
| 55.6 | Sixth temperature curve |
| 56.1 | First saved time |
| 56.2 | Second saved time |

What is claimed is:

1. A cooktop, comprising:
a glass ceramic cooking plate with at least one cooking zone;
at least one heater arranged below the glass ceramic cooking plate in a region of the cooking zone;
at least one infrared sensor having a sensing area arranged so as to face the cooking zone through the glass ceramic cooking plate;
electronics connected to the at least one infrared sensor, the electronics being configured to control a power output of the at least one heater based on an output signal of the at least one infrared sensor, and
wherein the glass ceramic cooking plate is made of a lithium aluminosilicate glass ceramic containing a composition (in percent by weight) of:

| | |
|---|---|
| Al₂O₃ | 18-23, |
| Li₂O | 2.5-4.2, |
| SiO₂ | 60-69, |
| ZnO | 0-2, |
| Na₂O + K₂O | 0.2-1.5, |
| MgO | 0-1.5, |
| CaO + SrO + BaO | 0-4, |
| B₂O₃ | 0-2, |
| TiO₂ | 2.3-4.5, |
| ZrO₂ | 0.5-2, |
| P₂O₅ | 0-3, |
| SnO₂ | 0-<0.6, |
| Sb₂O₃ | 0-1.5, |
| As₂O₃ | 0-1.5, |
| TiO₂ + ZrO₂ + SnO₂ | 3.8-6, |
| preferably V₂O₅ | 0.01-0.08, |
| Fe₂O₃ | 0.008-0.3, |

wherein the glass ceramic cooking plate has a gradient layer at or towards a surface thereof and an underlying core,
wherein the glass ceramic cooking plate has keatite mixed crystals as a predominant crystal phase in the core and high-quartz mixed crystals as a predominant crystal phase in the gradient layer, and
wherein the keatite mixed crystals have a crystal phase content that exceeds 50% a total crystal phase content of the high-quartz mixed crystals and the keatite mixed crystals in a depth of 10 μm or more.

2. The cooktop as claimed in claim 1, wherein the composition further comprises coloring oxides up to a maximum amount of 1.0 wt %.

3. The cooktop as claimed in claim 1, wherein the glass ceramic cooking plate has a thickness in a range between 2.8 mm and 4.2 mm.

4. The cooktop as claimed in claim 1, wherein the glass ceramic cooking plate has a transmittance, normalized to a glass ceramic cooking plate of 4 mm thickness, selected from the group consisting of greater than 5% at a wavelength of 3000 nm, greater than 7% at a wavelength of 3000 nm, greater than 18% at a wavelength of 3200 nm, greater than 24% at a wavelength of 3200 nm, greater than 37% at a wavelength of 3400 nm, greater than 43% at a wavelength of 3400 nm, greater than 51% at a wavelength of 3600 nm, greater than 54% at a wavelength of 3600 nm, and any combinations thereof.

5. The cooktop as claimed in claim 1, wherein the infrared sensor has a spectral sensitivity in a range of wavelengths between 2800 nm and 4400 nm.

6. The cooktop as claimed in claim 1, wherein the electronics being configured to control the power output of the at least one heater based on an emission coefficient of a piece of cookware on the region of the cooking zone.

7. The cooktop as claimed in claim 1, further comprising a conductor configured to guide heat radiation of a piece of cookware on the region of the cooking zone to the infrared sensor.

8. The cooktop as claimed in claim 1, wherein the sensing area of the infrared sensor faces a bottom or a lateral surface of a piece of cookware on the region of the cooking zone.

9. The cooktop as claimed in claim 1, wherein the glass ceramic cooking plate has a smooth surface on both faces thereof.

10. The cooktop as claimed in claim 1, further comprising a heater arranged on the glass ceramic cooking plate, wherein the heater is selected from the group consisting of a radiation heater, a halogen heater, an induction heater, and an electrical resistance heater.

11. The cooktop as claimed in claim 1, wherein the infrared sensor and the electronics are designed for control starting at a temperature of a piece of cookware on the region of the cooking zone of at least 90° C.

12. The cooktop as claimed in claim 1, wherein the infrared sensor and the electronics are designed for control starting at a temperature of a piece of cookware on the region of the cooking zone of at least 70° C.

13. The cooktop as claimed in claim 1, wherein the electronics are further configured to control an electrical appliance arranged outside the cooktop based on the output signal of the infrared sensor.

14. The cooktop as claimed in claim 13, wherein the electrical appliance is an exhaust hood.

15. The cooktop as claimed in claim 1, wherein the glass ceramic cooking plate has a reduced thickness in some areas, and wherein the gradient layer is provided in and/or beyond the areas of reduced thickness.

16. The cooktop as claimed in claim 1, wherein the glass ceramic cooking plate is has a bend and/or a three-dimension deformation, and wherein the gradient layer is provided in and/or beyond the bend and/or the three-dimensional deformation.

17. The cooktop as claimed in claim 1, wherein the glass ceramic cooking plate has at least one opening, and wherein the gradient layer is provided so as to extend to an edge of the opening and/or so as to extend on a wall of the opening.

18. The cooktop as claimed in claim 1, comprising a maximum fraction of diffused light, normalized to a glass ceramic cooking plate of 4 mm thickness, selected from the group consisting of not more than 15% at a wavelength of 470 nm, not more than 12% at a wavelength of 470 nm, not more than 20% in a range of wavelengths from 400 nm to 500 nm, not more than 17% in a range of wavelengths from 400 nm to 500 nm, not more than 6% at a wavelength of 630 nm, not more than 5% at a wavelength of 630 nm, not more than 4% at a wavelength of 630 nm, and any combinations thereof.

19. The cooktop as claimed in claim 1, comprising a light transmittance, normalized to a glass ceramic cooking plate of 4 mm thickness, that is less than or equal to 5% in a range of wavelengths from 380 nm to 780 nm.

20. The cooktop as claimed in claim 1, comprising a spectral transmittance of greater than 0.2% wherein at a wavelength of 420 nm.
